(19) United States
(12) Patent Application Publication
(10) Pub. No.: US 2012/0118396 A1
(43) Pub. Date: May 17, 2012

(54) METHOD AND DEVICE FOR SUPPLYING GAS

(76) Inventor: Willi Bayerl, Deisenhofen (DE)

(21) Appl. No.: 13/255,108

(22) PCT Filed: Jan. 22, 2010
(86) PCT No.: PCT/EP2010/000397

§ 371 Date: Sep. 30, 2011

(30) Foreign Application Priority Data
Mar. 13, 2009 (DE) 10 2009 013 133.7

(51) Int. Cl. F15D 1/00

(52) U.S. Cl. 137/14; 137/334

(57) ABSTRACT

The invention relates to a method and to a device for gassing, wherein a gas mixture of a gassing agent and of a cryogenic liquid is vaporized in that the mixture, which is pressurized in a storage container, is guided through a pressure reducing valve, so that the mixture is vaporized completely and the steam is supplied for gassing goods.

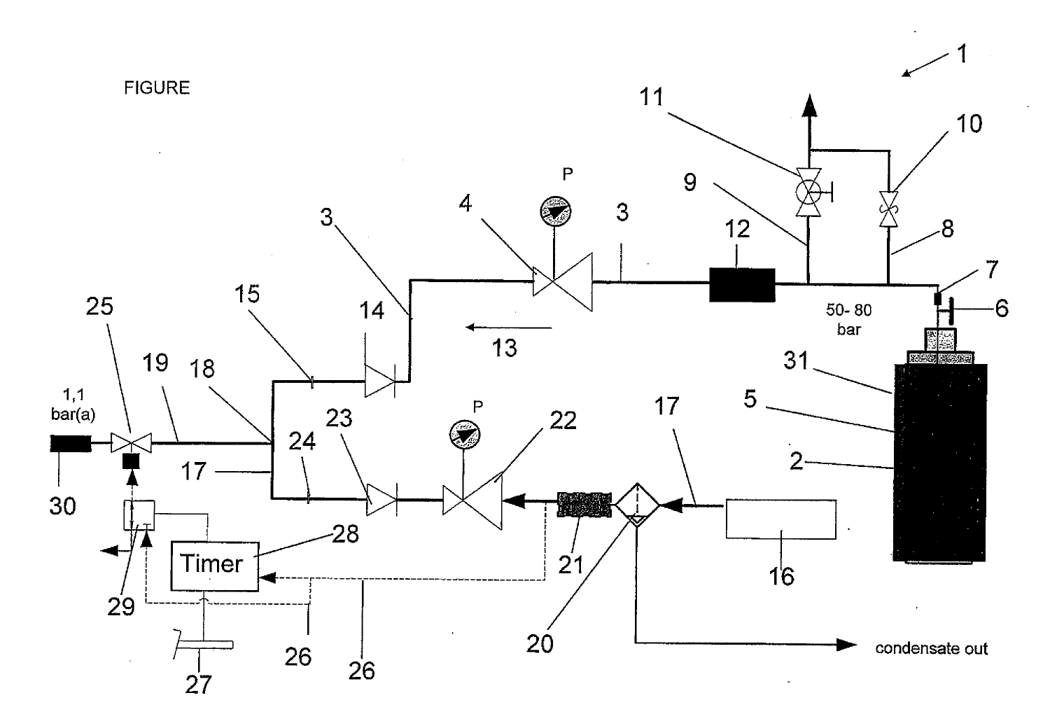

According to a first aspect of the instant invention, the temperature of the mixture is maintained in the storage container such that it forms an overcritical fluid. Through this, a distillation of the gassing agent is avoided.

According to a second aspect of the instant invention, the vaporized mixture is diffused by adding compressed air and the ratio between mixture and the compressed air is adjusted by means of replaceable screens and/or adjustable pressure reducing valves. Through this, the ratio between the mixture and the compressed air can be varied freely.

The instant invention relates to a method and a device for gassing. In particular, the invention relates to a method and a device, in the case of which a gassing agent, which is dissolved in a liquefied gas, is vaporized together with the liquefied gas, so that it can be used for gassing goods.

A device is known for gassing goods, such as fruit, in particular bananas, by means of which provision is made for a mixture of a medium, namely CO₂, which is liquefied under pressure, and for a gassing agent in pressure-resistant cylinders. From these cylinders, the mixture located therein is removed by means of an immersion pipe, is vaporized, guided via a pressure reducing valve and is diluted by supplying compressed air.

In the laboratory, this device works flawlessly. In practice, however, considerable problems arose. This device is used in fruit plantations, which are oftentimes located in areas having a high humidity. Through this, parts of the device are subjected to considerable corrosion. The power supply is furthermore highly unsteady, which is why electrically operating parts do not perform reliably. The air drawn in by a compressor for providing the compressed air contains a lot of dust, moisture and dirt, which further considerably impacts the function of the entire device.

The mixture in the cylinders is to encompass a predetermined volume ratio of the gas, which is liquefied under pressure and of the gassing agent. In practice, however, it turned out that the ratio of gas, which is liquefied under pressure, and gassing agent, which is discharged by the device, can deviate considerably from the ratio of the two components of the mixture, which is filled in the cylinder. It turned out that the ratio of gassing agent and of gas, which is liquefied under pressure, was correct initially, but that the portion of gassing agent increased continuously with the removal of the portion. In the case of a remaining filling level of approx. 20% of the cylinder, the portion of gassing agent was so high that the further gassing of such a cylinder is interrupted and a new cylinder is connected to the gassing device. In the case of the known device, it was thus only possible to utilize 80% of the cylinder content. Due to the fact that the gassing agent is typically a strong poison, it is extensive and thus expensive to dispose of the remainder of the cylinder content.

The invention is based on the object of creating a method and a device for gassing, by means of which the gassing can take place in a considerably more efficient manner.

A further object of the invention lies in the creation of a method and of a device for gassing, which can be designed to be more reliable than the above-described method and the above-described device.

One or a plurality of the above-specified objects are solved by means of a method comprising the features of claim 1 or of claim 6 and by means of a device comprising the features of claim 7 or comprising the features of claim 8. Advantageous embodiments of the invention are specified in the respective subclaims.

The method according to the invention relates to a method for gassing, wherein a mixture of a gassing agent and of a gas, which is liquefied under pressure, is vaporized, in that the mixture, which is pressurized in a storage container, is guided through a vaporizer and a pressure reducing valve, so that the mixture vaporizes completely and the steam is supplied for the gassing of goods.

According to the first aspect of the invention, the temperature of the mixture in the storage container is maintained in such a manner that it is an over-critical fluid.

The inventor of the instant invention recognized that, in the case of the method according to the state of the art, in the case of which the mixture is reserved in the storage container as a liquid, the gassing agent is distilled in response to the removal of the mixture, because the gas, which is liquefied under pressure, outgases to a considerably higher extent due to the considerably lower boiling point of the gas, which is liquefied under pressure, in relation to the gassing agent. Consequently, the gassing agent in the mixture, which remains in the storage container, is concentrated to an increasing extent.

By heating the mixture in the storage container in such a manner that it forms an overcritical fluid, which can also be identified as an overcritical state, a differentiation between liquid and gas can no longer be made in the fluid. The density of the gaseous state and of the liquid state of the medium approximate one another in the overcritical fluid.

Through this, the fluid is removed from the storage container at an accurately predefined ratio. A concentration of gassing agent does not take place. Through this, the content of the storage container can be used up almost completely, wherein the desired ratio between gassing agent and gas, which is liquefied under pressure, is always present. It is not necessary to dispose of the considerable quantities of the mixture, which includes gassing agents. This leads to a considerable increase in efficiency and to a cost reduction.

According to a further aspect of the instant invention, a diluting gas, in particular compressed air, is added to the vaporized mixture, so as to dilute it and to disperse it on the goods, which are to be gassed, wherein the ratio between the mixture and the diluting gas can be adjusted by means of replaceable screens and/or adjustable pressure reducing valves.

It is possible through this to vary the ratio between the mixture and the diluting gas. This mainly serves to adjust the gassing process to different applications, such as to different package sizes of the goods or different goods, for example. However, it is also possible to compensate concentration fluctuations of the gassing agent in the mixture by means of a correspondingly adapted portion of diluting gas by changing the ratio between the mixture and the diluting gas, so that approximately the same portion of gassing agent is always included in the entire discharged gassing flow.

A “gas liquefied under pressure” is a substance, which is gaseous under normal conditions (T=273.15 K and p=1.01325 bar) and which is pressurized in such a manner that it is present in the liquid aggregate state. CO₂ is preferably used as gas, which is liquefied under pressure.

Preferably, the mixture in the storage container is pressurized to 50 bar to 110 bar. A temperature of 35° C. to 40° C. is maintained.

In the event that the mixture is dispersed by adding compressed air as diluting gas, the compressed air is preferably refined in that it is filtered and/or in that the moisture contained therein is separated.

A device according to the invention for gassing according to a first aspect of the instant invention comprises
a storage container for accommodating a pressurized mixture of a gassing agent and a gas, which is liquefied under pressure,
a gassing line for removing the mixture from the storage container,
a vaporizer arranged in the gassing line and a pressure reducing valve, for vaporizing the mixture and for reducing the pressure, and
a device for maintaining the temperature for maintaining the temperature of the gas mixture located in the storage container in such a manner that it is an overcritical fluid.

A device for gassing according to a second aspect of the instant invention comprises
a storage container for accommodating a pressurized mixture of a gassing agent and a gas, which is liquefied under pressure,
a gassing line for removing the mixture from the storage container,
a vaporizer arranged in the gassing line and a pressure reducing valve, for vaporizing the mixture and for reducing the pressure,
a compressed air line for supplying diluting gas, so as to dilute the vaporized mixture by adding diluting gas, and
a replaceable screen and/or an adjustable pressure reducing valve for adjusting the ratio between the diluting gas and the mixture, at least in the gassing line and/or in the diluting line.

Preferably, the first and the second aspect of the instant invention are used in combination.

The device according to the invention preferably encompasses an output valve for controlling the output of the vaporized mixture, wherein the output valve is controlled pneumatically.

The pneumatically controlled output valve can be provided with a time delay device in such a manner that, when the output valve is controlled, it is kept open for a predetermined period of time.

The storage container is preferably a pressure cylinder, in which the pressurized mixture can be transported from a filling station to the gassing device. For example, the device for maintaining a temperature is a heating mat, which can be nestled around the pressure cylinder.

It is also possible in the context of the invention to provide for different pressure-resistant storage containers, which can be provided with an external or internal device for maintaining a temperature. A water quench, a radiant heater or other radiators, for example, are suitable external devices for maintaining a temperature. The device for maintaining a temperature can also be integrated directly into the storage container, for example in the form of electric heating wires, which are arranged on the outer or inner side of the walls of the storage container, or heat pipes, through which a heating medium flows.

Preferably, all of the essential parts, which come into contact with the mixture and possibly with the diluting gas or the compressed air, respectively, are made of a corrosion-resistant material. This applies in particular to membranes of valves.

The invention will be defined below by means of an exemplary embodiment of a device according to the invention, which is shown in the sole FIGURE.

The gassing device 1 according to the invention comprises a storage container 2 for accommodating a pressurized mixture of a gassing agent and a gas, which is liquefied under pressure, a gassing line 3 for removing the mixture from the storage container 2 and a vaporizer 12, which is arranged in the gassing line, and a pressure reducing valve 4, for reducing the pressure of the mixture.

Provision is made in the storage container 2 for an immersion pipe 5, which extends from outside of the storage container 2 into an area shortly above a bottom wall of the storage container 2. A closing valve 6 and a coupling element 7 for connecting the immersion pipe 5 to the gassing line 3 is arranged on the free end of the immersion pipe, which projects from the storage container 2. A first branch line 8 and a second branch line 9 branch off from the gassing line 3, wherein an overpressure valve 10, which prevents the build-up of an overpressure of, for example, more than 100 bar in the gassing line, is arranged in the first branch line 8. A further closing valve 11, by means of which the content of the storage container can be drained in a controlled manner or by means of which the line system can be flushed, respectively, is arranged in the second branch line.

The vaporizer 12 is located in the gassing line 3 in flow direction 13 upstream of the pressure reducing valve 4. The vaporizer 12 is provided with a heating device, which heats the fluid to a temperature of e.g. 60° C. to 90° C. This heating device is embodied so as to be self-controlled. The heating of the fluid is necessary, so as to reliably avoid a condensation of the fluid in response to the pressure reduction, which is to be carried out at the pressure reducing valve 4. The fluid is vaporized completely at the vaporizer before it is supplied to the pressure reducing valve 4.

In the instant exemplary embodiment, a pressure reduction to 5.8 bar takes place. A return valve 14, by means of which a flow opposite to the flow direction 13 is avoided, is connected downstream from the pressure reducing valve 4 in flow direction 13.

A screen follows the return valve 14 in the gassing line 3. This screen is a disk comprising an opening having a predetermined diameter. The screen 15 of the instant exemplary embodiment encompasses an opening comprising a diameter of 1.0 mm. The screen 15 can be replaced, so that a screen comprising a different diameter can also be used. The quantity of the fluid, which flows through the screen 15, is substantially determined by the pressure, which is adjusted by the pressure reducing valve 4 and by the size of the through opening of the screen 15. For instance, the flow volume of fluid can be changed by changing the pressure and/or the through opening of the screen.

A compressed air line 17 leads from a compressor 16 to a crossing point 18, at which the compressed air line 17 and the gassing line 3 come together and merge into a gassing agent discharge line 19. A moisture separator 20, a filter device 21, a pressure reducing valve 22, a return valve 23 and a replaceable screen 24 are arranged in the compressed air line 17 between the compressor 16 and the crossing point 18.

Moisture is removed from the compressed air by means of the moisture separator 20.

The filter device 21 encompasses a filter for filtering dust and dirt from the compressed air. This also allows for the operation of this device in a dusty, dirty environment, as it is common in fruit plantations.

The pressure reducing valve of the instant exemplary embodiment is adjusted in such a manner that a pressure of 4.16 bar prevails on the output side of the pressure reducing valve 22.

The screen 24 of this exemplary embodiment encompasses a through opening with a diameter of 2.0 mm.

The pressures, which are determined by the pressure reducing valves 4, 22, and the through openings of the two screens 15, 24 are adjusted in such a manner in the instant exemplary embodiment that the portion of the mixture of the total flow is 20% by volume and the portion of compressed air of the total flow is 80% by volume.

A pneumatically controlled output valve 25 is located in the gassing agent discharge line 19. A control line 26 branches off from the compressed air line 17 in the area between the filter device 21 and the pressure reducing valve 22 and leads to the output valve 26. A foot switch 27, a time delay device 28 and a control valve 29 is arranged in this pneumatic control line. The control valve 29 is located in the control line 26 upstream of a control input of the output valve 25. The time delay device 28 is connected to the foot switch 27 and to a control input of the control valve 29 in such a manner that, upon activation of the foot switch for a predetermined period of time, the control input of the control valve 29 is controlled in such a manner that the control valve is kept open, whereby a control pressure is applied to the control input of the output valve 25 via the control line 26. Through this, the output valve is kept open for the period of time, which is delayed by the time delay device. By activating the foot switch 27 once, the output valve 25 thus allows for a certain period of time to pass by discharging a certain quantity of gassing medium. A diffuser nozzle 30, from which the gassing medium escapes at a pressure of 1.1 bar and, in the instant exemplary embodiment, at a quantity of 200 l/m, is arranged downstream from the output valve 25.

According to the invention, the storage container 2 is provided with a device for maintaining a temperature 31, which holds the mixture of a gas, which is liquefied under pressure and a gassing agent, which are contained in the storage container 2, at a temperature, so that this mixture forms an overcritical fluid. In an overcritical fluid, the aggregate states liquid and gaseous can no longer be distinguished. It is avoided through this that the liquefied gas, which boils at a considerably lower temperature than the gassing agent, does not merge into a gas phase and separates from the mixture, which would have the effect that the gassing agent would accumulate in the mixture.

In the event that the cryogenic medium CO₂ (boiling point of −78° C.) and the gassing agent ETF (boiling point of +54° C.) is at a ratio of 16.7% by weight of ETF in CO₂, the mixture becomes an overcritical fluid in response to a pressure of 50 to 100 bar and at a temperature of 35° C. to 40° C.

Gas, which is liquefied under pressure, is added to the gassing agent in this mixture, because this liquefied gas gasses in a residue-free manner in response to a sufficient heating by means of the heating device 12. The use of CO₂ furthermore increases the efficiency of the gassing agent, because insects are prompted to breathe more in response to the increased CO₂ portion and the intake of the gassing agent is thus improved. In addition, CO₂ is highly inert, so that the mixture in the storage container 2, typically a pressure cylinder, can be stored for a long time at room temperature.

This device is used in such a manner that goods, in particular fruit, are gassed with the mixture of the gas mixture and the compressed air in response to the packaging in gas-tight transport containers, wherein a predetermined quantity of gassing agent is supplied by activating the foot switch 27 once. After the supply of the gassing agent, the container is closed.

In the case of the above-described exemplary embodiment, a ratio between mixture and compressed air of 20% by volume to 80% by volume is attained at a pressure of 5.8 bar in the gassing line 3 and a screen comprising a through diameter of 1.0 mm in the gassing line 3 and a pressure of 4.16 bar in the compressed air line 17 and a screen comprising a diameter of 2.0 mm in the compressed air line 17, which leads to a total flow of 200 l/min.

The following table lists the portion of the mixture in % by volume, the diameter of the screen I in mm, the portion of the compressed air in % by volume, the diameter of the screen II in mm and the entire flow in l/min for a pressure of 6 bar in the gassing line 3 as well as in the compressed air line 17.

| | | Compressed | | |
|---|---|---|---|---|
| Mixture | | air | | |
| [% by | Diameter | [% by | Diameter | Total flow |
| volume] | [mm] | volume] | [mm] | l/min |
| 5 | 0.34 | 95 | 1.35 | 100 |
| 10 | 0.49 | 90 | 1.31 | 100 |
| 15 | 0.59 | 85 | 1.28 | 100 |
| 20 | 0.69 | 80 | 1.25 | 100 |
| 25 | 0.77 | 75 | 1.2 | 100 |
| 5 | 0.49 | 95 | 1.9 | 200 |
| 10 | 0.69 | 90 | 1.85 | 200 |
| 15 | 0.84 | 85 | 1.8 | 200 |
| 20 | 0.97 | 80 | 1.75 | 200 |
| 25 | 1.09 | 75 | 1.69 | 200 |
| 5 | 0.59 | 95 | 2.33 | 300 |
| 10 | 0.84 | 90 | 2.28 | 300 |
| 15 | 1.03 | 85 | 2.2 | 300 |
| 20 | 1.09 | 80 | 2.15 | 300 |
| 25 | 1.33 | 75 | 2.7 | 300 |
| 5 | 0.77 | 95 | 3 | 500 |
| 10 | 1.09 | 90 | 2.93 | 500 |
| 15 | 1.33 | 85 | 2.85 | 500 |
| 20 | 1.53 | 80 | 2.76 | 500 |
| 25 | 1.72 | 75 | 2.67 | 500 |

By means of this table, it can be seen that the portion of the mixture can be varied highly by changing the through opening of the screen. Likewise, the ratio of the mixture to the compressed air can be adjusted by changing the pressure in the gassing line 3 and in the compressed air line 17.

### LIST OF REFERENCE NUMERALS

1 gassing device

2 storage container

3 gassing line

4 pressure reducing valve

5 immersion pipe

6 closing valve

7 coupling element

8 first branch line

9 second branch line

10 overpressure valve

11 closing valve

12 vaporizer

13 flow direction

14 return valve

15 screen

16 compressor

17 compressed air line

18 crossing point

19 gassing agent discharge line

20 moisture separator

21 filter device

22 pressure reducing valve

23 return valve

24 screen

25 output valve

26 control line

27 foot switch

28 time delay device

29 control valve

30 diffuser nozzle

31 device for maintaining a temperature

1. A method for gassing, wherein a mixture of a gassing agent and a gas, which is liquefied under pressure, is vaporized, in that the mixture, which is pressurized in a storage container, is guided through a vaporizer, so that the mixture is vaporized completely and the steam is supplied for the gassing of goods,
characterized in that the temperature of the mixture is maintained in the storage container in such a manner that it is an overcritical fluid

2. The method according to claim 1,
characterized in that CO₂ is used as gas, which is liquefied under pressure.

3. The method according to claim 1,
characterized in that the mixture is under a pressure of from 50 bar to 100 bar in the storage container and in that a temperature of from 35° C. to 40° C. is maintained.

4. The method according to claim 1,
characterized in that the vaporized mixture is diluted and dispersed by adding a diluting gas.

5. The method according to claim 4,
characterized in that the dilution gas is compressed air, which is refined, in that it is filtered and/or in that the moisture contained therein is separated.

6. The method for gassing, in particular according to claim 1, wherein a mixture of a gassing agent and a gas, which is liquefied under pressure, is vaporized, in that the mixture, which is pressurized in a storage container, is guided through a vaporizer and a pressure reducing valve, so that the mixture is vaporized completely and the steam is supplied for the gassing of goods, wherein the vaporized mixture is diffused by adding a diluting gas,
characterized in that the ratio between the mixture and the diluting gas can be adjusted by means of replaceable screens and/or adjustable pressure reducing valves.

7. A device for gassing comprising
a storage container for accommodating a pressurized mixture of a gassing agent and a gas, which is liquefied under pressure,
a gassing line for removing the mixture from the storage container,
a vaporizer, which is arranged in the gassing line, and a pressure reducing valve, for reducing the pressure of the mixture
characterized by a device for maintaining a temperature for maintaining the temperature of the gas mixture located in the storage container in such a manner that it is an overcritical fluid.

8. The device according to claim 7 comprising
a storage container for accommodating a pressurized mixture of a gassing agent and a gas, which is liquefied under pressure,
a gassing line for removing the mixture from the storage container,
a vaporizer, which is arranged in the gassing line, and a pressure reducing valve, for reducing the pressure of the mixture,
a diluting gas line for supplying a diluting gas, so as to diffuse the vaporized mixture by adding the diluting gas,
characterized in that a replaceable screen and/or an adjustable pressure reducing valve for adjusting the ratio between the diluting gas and the mixture are arranged at least in the gassing line and/or in the compressed air line.

9. The device according to claim 7,
characterized in that the vaporizer, which is arranged in the gassing line between the storage container and the pressure reducing valve, encompasses a heating device for heating the mixture, which is to be vaporized.

10. The device according to claim 7,
characterized in that a branch line, in which an overpressure valve is arranged, branches off from the gassing line adjacent to the storage container.

11. The device according to claim 7,
characterized in that provision is made for an output valve for outputting the vaporized mixture, wherein the output valve is controlled pneumatically and is preferably provided with a time delay device such that, in response to a control of the output valve, said output valve is kept open for a predetermined period of time.

12. The device according to claim 7,
characterized in that the storage container is a pressure cylinder and the device for maintaining a temperature is a heating mat, which can be nestled around the pressure cylinder.

13. The device according to claim 8,
characterized in that the diluting gas is compressed air and the diluting gas line is a compressed air line, in which a filter device for filtering the compressed air and/or a moisture separator are arranged.

14. The device according to claim 7,
characterized in that all of the essential parts, which come into contact with the mixture and possibly with the diluting gas, and in particular membranes of valves are embodied from a corrosion-resistant material.
